(19) United States
(12) Patent Application Publication
(10) Pub. No.: US 2004/0113744 A1
(43) Pub. Date: Jun. 17, 2004

(54) Complex magnetic material, and core and magnetic element using the complex magnetic material

(75) Inventors: Shigetoshi Watanabe, Tsurugashima-Shi (JP); Kazuhiro Nakayama, Tsurugashima-Shi (JP); Hiromi Murakami, Tsurugashima-Shi (JP); Yoshitaka Murakami, Tsurugashima-Shi (JP)

Correspondence Address: RENNER, KENNER, GREIVE, BOBAK,, TAYLOR & WEBER, Fourth Floor, First National Tower, Akron, OH, 44308-1456, US

(73) Assignee: Toko Kabushiki Kaisha

(21) Appl. No.: 10/729,001

(22) Filed: Dec. 5, 2003

(30) Foreign Application Priority Data
Dec. 6, 2002 (JP) 2002-355066

(51) Int. Cl. H01F 27/24

(52) U.S. Cl. 336/233

(57) ABSTRACT

Conventional single-piece molded-type inductors are made by pressure-molding magnetic particles of ferroalloy, and have a problem that their insulation resistance drops sharply when placed in a high-temperature environment. Complex magnetic powder is obtained by mixing ferrous crystalline alloy magnetic powder with ferrous amorphous alloy magnetic powder, a connecting agent of 1 wt % to 10 wt % of the mixed magnetic powder being additionally mixed therein, producing a complex magnetic material for use in electronic components. Furthermore, a core is pressure-molded from the complex magnetic material, and a coil is buried in the core to obtain a magnetic element, such as an inductor.

### BACKGROUND OF THE INVENTION

1. Field of the Invention

This invention relates to a magnetic material comprising ferroalloy, and a core and a magnetic element, such as an inductor, comprised by using the magnetic material.

2. Description of the Related Art

Processing speeds of laptop computers and MPUs for servers have become much faster in recent years, resulting in a sharp increase in the amount of current supplied.

Noticeable advancements has also been made in achieving higher switching frequencies, which are aimed at producing smaller DC-DC converters, with a consequent demand for lower inductances in the power inductors used in DC/DC converters.

Conventionally, this type of power inductor is realized by using a ferrite magnetic body; however, although the ferrite magnetic body has high permeability, suitable for high inductance, it has a comparatively low saturation flux density of between 0.3 T (Tesla) and 0.4 T, and therefore tends to become magnetically saturated when a large current is applied, making it unsuitable for meeting the demands of larger currents. By contrast, the saturation flux density of a dust core comprising a metallic magnetic body is approximately 0.8 T, enabling it to handle a large current since magnetic saturation does not occur when the large current is applied.

A dust core comprising a metallic magnetic material having twice the saturation flux density of ferrite is also highly adaptable for miniaturization. In the troidal core shown in FIG. 3, where the average length of the magnetic path is A, the cross-sectional area is S, the number of coil windings is N, the coil inductance is Lo, the saturation current value is Is, the permeability is μ, and the saturation flux density is Bm, the following formulae can be expressed:

Is=Bm·A/(μ·N) (1)

Lo=μ·S·N²/A (2)

From the formula (1), the average magnetic path length A is

A=μ·N·Is/Bm (3)

Inserting this in formula (2) obtains the cross-sectional area S

S=Is·Lo/(N−Bm) (4)

and the volume V of the troidal core (V=A.S) becomes

V=(μ/Bm²)·Is²Lo (5)

Therefore, when the specifications for Is and Lo have been determined, the required volume of the core is proportionate to μ/Bm².

When using a ferrite magnetic body as the power inductor, a gap is generally provided in the magnetic circuit to improve the magnetic saturation characteristics. The ferrite material itself has high permeability, but when a gap is provided, the effective permeability μe falls to approximately 40, which is the roughly same as that of a metallic magnetic body. When the effective permeabilities of the metallic magnetic body dust core and the ferrite core are made roughly equal, the required volume of the core is smaller, being inversely proportionate to Bm². Since the saturation flux density Bm of the dust core comprising the metallic magnetic body is approximately twice that of ferrite, the volume of the magnetic body in the power inductor using the metallic magnetic body can be reduced to approximately one-quarter of the volume of the ferrite, allowing substantial miniaturization.

A single-piece mold-type inductor comprises a winding-type coil and a plate-like conductor, which are buried in a complex magnetic powder formed by adding an insulating connecting agent to magnetic powder, and can simultaneously realize increased current and miniaturization, being suitable for either of these requirements. Its simple structure makes it easy to construct, and it can be manufactured inexpensively. FIGS. 1 and 2 show example constitutions of a single-piece mold-type inductor.

The inductor shown in FIG. 1 comprises a winding-type coil 2 buried in a molded body 1, pressure-molded from magnetic powder, the particle surfaces having been insulated beforehand. An electrode is attached to the molded body 1 by an adhesive, or by partially burying the electrode 3 in the molded body 1, or another such method, and connects to the terminal of the coil 2.

The inductor shown in FIG. 2 uses a meandering flat plate-like conductor 4 instead of the winding-type coil of FIG. 1; the plate-like conductor 4 is buried in the molded body 1, and the terminal of the plate-like conductor 4 is extracted to the outside of the molded body 1 to form the electrode 3.

As shown in FIG. 4, a single-piece mold-type inductor equivalently comprises an inductance L and an insulation resistance Rz of the molded body 1, which are connected in parallel between two electrodes 3. When the insulation resistance Rz decreases due to high temperature deterioration or the like, the current flowing to the insulation resistance Rz increases and heats up, increases the temperature of the molded body. As the temperature of the molded body rises, thermal deterioration increases, causing the insulation resistance Rz to decrease further, and thereby producing even greater heat. This phenomenon may gradually accelerate until the inductor reaches thermal runaway, damaging the inductor and the surrounding electronic components, including the substrate.

FIG. 5 shows measurements of change in the conversion efficiency when the value of the resistance R, connected in parallel to the inductance L in a step-down DC/DC converter, is changed. There is no change in the efficiency when the parallel resistance R has a high value, but the efficiency begins to decrease at below around 10 KΩ and drops sharply thereafter. Therefore, 10 KΩ may be thought of as the lower limit of the insulation resistance in the single-piece mold-type inductor.

Japanese Patent Application Laid-open No. 1997-120926 describes a conventional pressure-molded inductor using malleable iron magnetic powder. Japanese Patent Application Laid-open No. 2002-289417 discloses a conventional inductor using ferroalloy magnetic powder, which Cr, Si, and the like, have been added to. An oxide film of phosphoric acid, boric acid, and such like, was formed on this type of magnetic powder, the granules of the magnetic powder were coated with a heat-resistance thermosetting resin to increase their insulation characteristics and append a connecting force, thereby obtaining a complex magnetic powder, which was used to construct an inductor such as that shown in FIG. 1. The complex magnetic powder was pressure-molded to obtain a molded body 1 having a breadth of 7 mm, width of 7 mm, and height of 3 mm, and, after pressure-molding, the molded body 1 was heated for one hour at 150 degrees C.

FIG. 6 shows drop characteristics in the insulation resistance when these inductors are placed in a high-temperature environment of 150 degrees C. As clearly shown in FIG. 6, although the initial value of the insulation resistance is high, in an environment of 150 degrees C., the insulation resistance drops over time. In the case of pure iron powder, it takes one-hundred hours to drop to 10 kΩ, which is the lower limit of insulation resistance coming from the earlier circuit operation; in the case of alloy magnetic powder comprising 5% Cr, 3% Si, and the remainder Fe, it takes two-thousand hours to drop to the same level.

A conventional method known to be effective in preventing a drop in the insulation resistance at high temperatures comprises coating the metallic magnetic powder with a heat-resistant resin such as silicon, or glass or the like, and, after pressure-molding, annealing it at several hundred degrees. However, in the case of inductors having the constitutions shown in FIGS. 1 and 2, a thermosetting resin such as epoxy resin is used as the insulating connecting agent, and an urethane resin film or the like is used as the insulating film for the coil material, making it impossible to anneal at several hundred degrees C., as is usual in order to eliminate residual stress at the time of pressure-molding, since resins of this type will carbonize.

Tests have confirmed that the speed at which the insulation resistance decreases complies to the Arrhenius reaction formula stating that “the reaction speed doubles each time the temperature rises by 10 degrees C”. That is, when the time taken for the insulation resistance to drop to a given value is represented by La in an environment with a temperature Ta of degrees C., and by Lb in an environment with a temperature Tb of degrees C., and assuming Tb>Ta, then, based on the Arrhenius reaction formula, the following can be expressed:

La=Lb·2^{(Th-Ta)/10} (6)

The maximum temperature during actual use in personal computers, servers, and the like, may be regarded as approximately 100 degrees C. Accordingly, based on the “time taken for the insulation resistance to drop to 10 kΩ (hereinafter termed “lifetime”) at 150 degrees shown in FIG. 6, the lifetime at 100 degrees C. may be estimated from the formula (6) as 3,200 hours in the case of pure iron powder, and 64,000 hours in the case of ferroalloy magnetic powder. Considering that servers and the like have product lifetimes of ten years of constant operation, the above times are extremely short. With advances in miniaturization and increased capacity of power devices in recent years, the temperature environments required for inductors are becoming harsher each year, so that a minimum lifetime of ten years at 100 degrees C. is now demanded.

On the other hand, amorphous alloy magnetic powder creates a more stable oxide film over the particle surfaces than crystalline alloy magnetic powder, and does not have the sort of crystal particle interface that exists in the crystalline alloy magnetic powder, achieving more stable particle surfaces. FIG. 6 also shows the insulation resistance drop characteristics when amorphous alloy magnetic powder is used as the complex magnetic material, and it can be seen that the drop in the insulation resistance in this case is less than that of other materials, making it extremely stable.

Table 1 shows a comparison of the characteristics of the compressed-powder, core when the magnetic powder material is changed. The amorphous alloy magnetic powder (c) has very little drop in the insulation resistance, but its magnetic and electrical characteristics are inferior to those of the pure iron powder (a) and the ferrous crystalline alloy magnetic powder (d). Furthermore, the amorphous alloy magnetic powder (c) is itself an extremely hard material, which shows little plastic deformation at the time of pressure-molding; this results in poor adhesion between the particles and consequently weakens the pressed-powder magnetic core molded body.

TABLE 1

| | (a) | (b) | (c) | (d) |
|---|---|---|---|---|
| compressed | pure iron | crystalline | amorphous | amorphous |
| powder core | powder | alloy | alloy | alloy |
| material | | magnetic | magnetic | magnetic |
| | | powder | powder | powder |
| annealing | no | no | no | yes |
| actual | good | moderate | poor | good |
| permeability | | | | |
| direct current | good | moderate | moderate | good |
| overlay | | | | |
| characteristics | | | | |
| core loss | good | moderate | moderate | good |
| insulation | poor | moderate | good | good |
| resistance drop | | | | |
| characteristics | | | | |
| Pressure- | goo | good | poor | poor |
| molding | | | | |
| characteristics | | | | |

To obtain the original magnetic characteristics of the amorphous alloy magnetic powder, residual stress and the like at the time of pressure-molding must be relieved by annealing. Annealing improves all the characteristics of the amorphous alloy magnetic powder except its pressure-molding characteristics, as shown in Table 1. However, the annealing temperature rises to approximately 470 degrees C., which is between the glass transition temperature and crystallizing commencement temperature of amorphous alloys. Since the resin for connecting and the insulating film resin of the wire would carbonize at this temperature, it has not been possible to use such amorphous alloy magnetic powder for the single-piece mold-type inductors of the constitutions shown in FIGS. 1 and 2.

In single-piece mold-type inductors of complex magnetic materials using thermosetting resin as the connecting material, since the electrode contacts the complex magnetic material, an insulation resistance enters the complex magnetic material equivalently in parallel with the inductance. When the complex magnetic material comprises malleable iron magnetic powder or ferrous alloy magnetic powder, the insulation resistance with drop sharply in a high-temperature environment. When the insulation resistance drops below 10 kΩ while the circuit is operational, the inductor will fall into thermal runaway leading to breakage; for such reasons, it has been difficult to actually use this type of single-piece mold-type inductor.

### SUMMARY OF THE INVENTION

Accordingly, it is an object of this invention to reduce the drop in insulation resistance in high-temperature environments in a complex magnetic material suitable for single-piece mold-type inductors.

This invention provides a complex magnetic powder, which is obtained by mixing ferrous crystalline alloy magnetic powder with ferrous amorphous alloy magnetic powder, a connecting agent of 1 wt % to 10 wt % of the mixed magnetic powder being additionally mixed therein. This invention further provides a core, which is pressure-molded from the complex magnetic material, and a magnetic element comprising a coil or a flat plate-like conductor, which is buried in the core.

### BRIEF DESCRIPTION OF THE DRAWINGS

FIG. 1 is a perspective view showing a first example of an inductor;

FIG. 2 is a perspective view showing a second example of an inductor;

FIG. 3 is a perspective view of a troidal coil;

FIG. 4 is an equivalent circuit diagram of a single-piece molded-type inductor;

FIG. 5 is a diagram showing changes in the conversion efficiency of a DC/DC inductor using parallel resistance;

FIG. 6 is a diagram showing drop characteristics in insulation resistance at 150 degrees C.;

FIG. 7 is a characteristics diagram showing permeability with respect to the matching ratio of the complex magnetic material of this invention;

FIG. 8 is a characteristics diagram showing core loss with respect to the matching ratio of the complex magnetic material of this invention;

FIG. 9 is a characteristics diagram showing insulation resistance with respect to the matching ratio of the complex magnetic material of this invention; and

FIG. 10 is a diagram showing changes in the insulation resistance and permeability of a molded body with respect to the matching amount of an insulating connecting material.

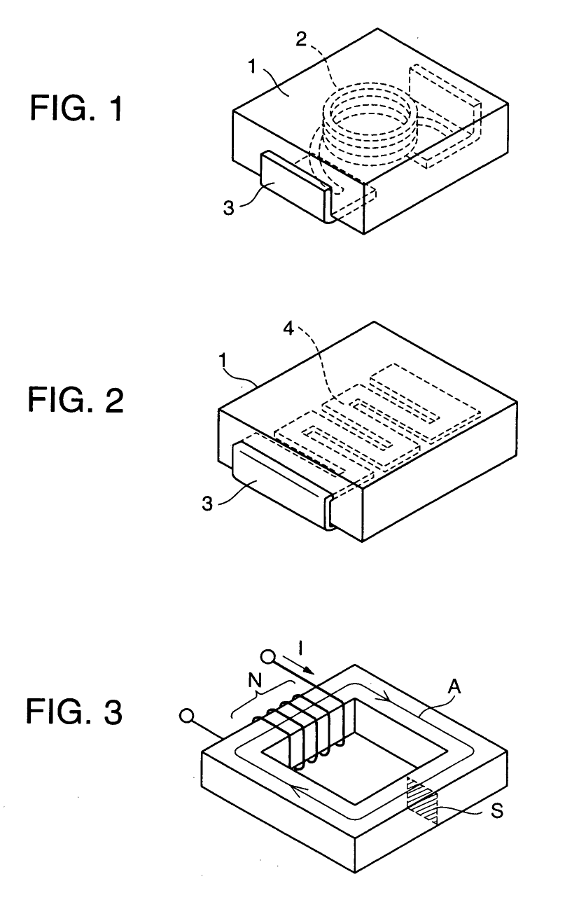

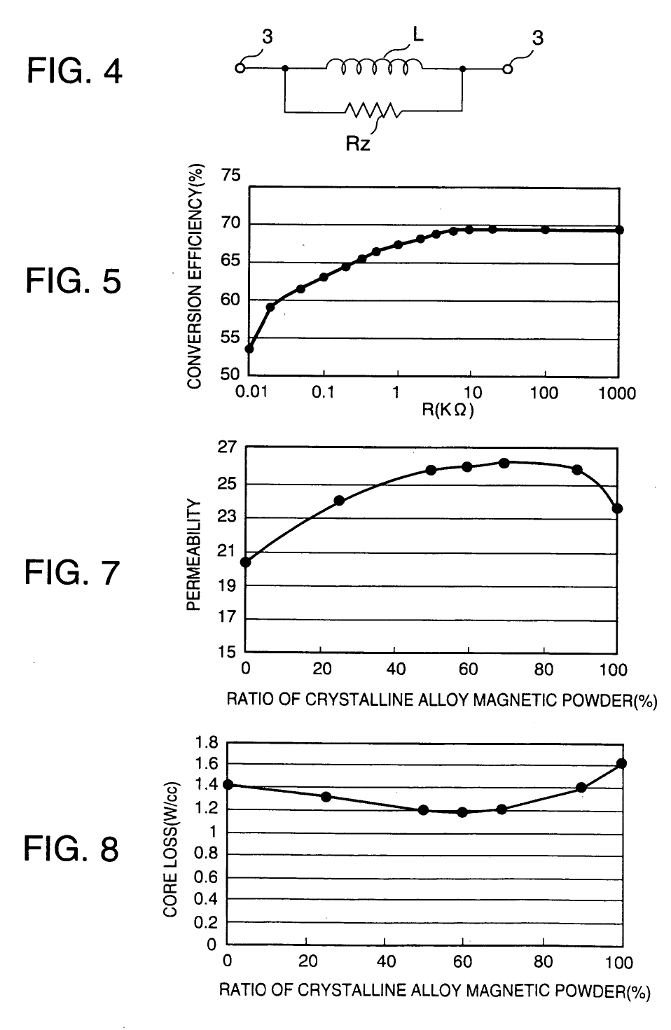

### PREFERRED EMBODIMENT OF THE INVENTION

Subsequently, an embodiment of this invention will be explained. Firstly, there were prepared several types of mixed magnetic powder, comprised by mixing a ferrous crystalline alloy magnetic powder with a ferrous amorphous alloy magnetic powder at matching ratios of between 10 wt % to 90 wt %, and 90 wt % to 10 wt %, respectively, and insulating connecting agents containing mixed magnetic powder of 3 wt % were mixed into these mixed magnetic powders (100 wt %) to obtain several types of complex magnetic materials.

Si and Cr accounted for 7 wt % of the crystalline alloy magnetic powder of these complex magnetic materials, the remainder comprising iron; in the case of the amorphous alloy magnetic powders, Si and Cr accounted for 7 wt %, with the remainder comprising iron. Several wt % of a smoothing agent, such as stearic chloride, was added to and mixed with particles of the complex magnetic material containing an insulating connecting agent of epoxy resin, and the resultant mixture was dried and shaped into granule-like particles. These magnetic particles were filled into a press mold, and press-molded to produce a ring core having an outer diameter of 14 mmφ, an inner diameter of 10 mmφ, and a height of 3 mm, which was thermo-set for one hour at 150 degrees C.

Incidentally, the average particle diameters of the crystalline alloy magnetic powder and the amorphous alloy magnetic powder should both preferably be between 1 μm and 50 μm. When the average particle diameter is less than 1 μm, the effective permeability of the molded body becomes insufficient, and a diameter of greater than 50 μm causes too much eddy-current loss.

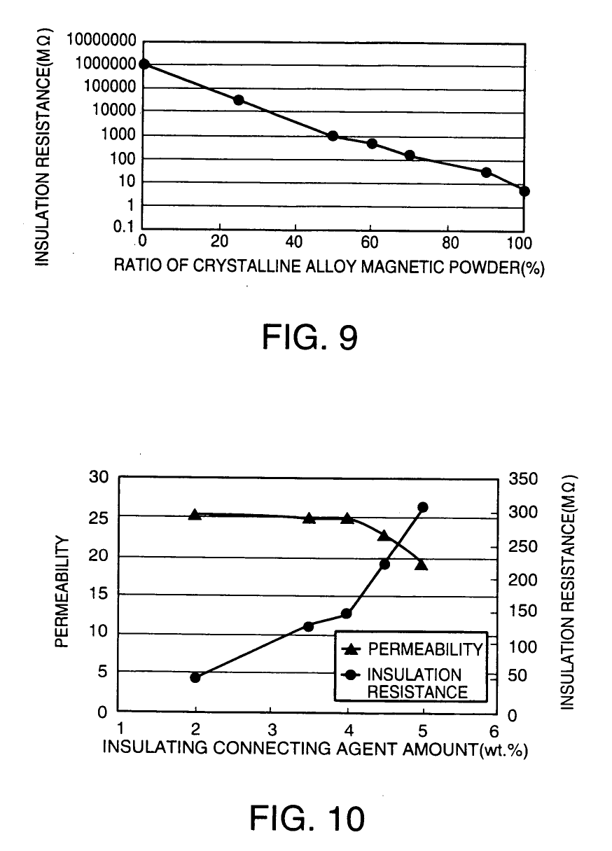

FIGS. 7 to 9 show characteristics of ring cores, pressure-molded from particles of complex magnetic material having different mixing ratios between the crystalline alloy magnetic powder and the amorphous alloy magnetic powder. FIG. 7 shows permeability at 1 MHz, FIG. 8 shows core loss at a frequency of 300 kHz and a magnetic flux density of 40 mT. FIG. 9 shows changes in the insulation resistance, measured after heating at 150 degrees C. for two hundred hours, and then applying a dc voltage of 25 V. As is clear from FIG. 7, when the ratio of the crystalline alloy magnetic powder is between 25 wt % and 90 wt %, and the ratio of the amorphous alloy magnetic powder is between 75 wt % and 10 wt %, their permeability is higher than when either is 100 wt %. As shown in FIG. 8, the core loss of the magnetic body, which is a problem at high frequency and high power, is also improved.

As is clear from FIG. 9, the lower the ratio of the crystalline alloy magnetic powder, the smaller the decrease in the insulation resistance. However, there is a problem that the molded body lacks strength when there is a small amount of crystalline alloy magnetic powder. In consideration of the strength of the molded body, the matching ratio of the crystalline alloy magnetic powder in the mixed magnetic powder should preferably be more than 60 wt %. Therefore, considering the results of FIGS. 7 and 8 jointly, the matching ratio of the mixed magnetic powder should be 60 wt % to 90 wt % of crystalline alloy magnetic powder, and 40 wt % to 10 wt % of amorphous alloy magnetic powder.

FIG. 10 is a diagram showing changes in the permeability and insulation resistance of the ring core when the matching amount of the insulating connecting agent is altered in mixed magnetic powder comprising 75 wt % crystalline alloy magnetic powder, and 25 wt % amorphous alloy magnetic powder. As shown in FIG. 10, to prevent a considerable drop in the permeability, and to obtain insulation resistance with good anti-drop characteristics, the insulating connecting agent amount should be between 3 wt % and 4.5 wt %.

By mixing and pressure-molding comparatively soft crystalline alloy magnetic powder with extremely hard amorphous alloy magnetic powder, better permeability and core loss are obtained than when either of these powders is used independently. It is assumed that a new physical phenomenon is produced by mixing them. This physical phenomenon will hereinafter be termed “maximum density filling effect”. As described above, this “maximum density filling effect”, achieved by mixing the crystalline alloy magnetic powder and the amorphous alloy magnetic powder, not only improves the anti-drop characteristics of the insulation resistance, which was the initial aim, but also, through synergism, obtains excellent magnetic characteristics; it is therefore regarded as having great future potential.

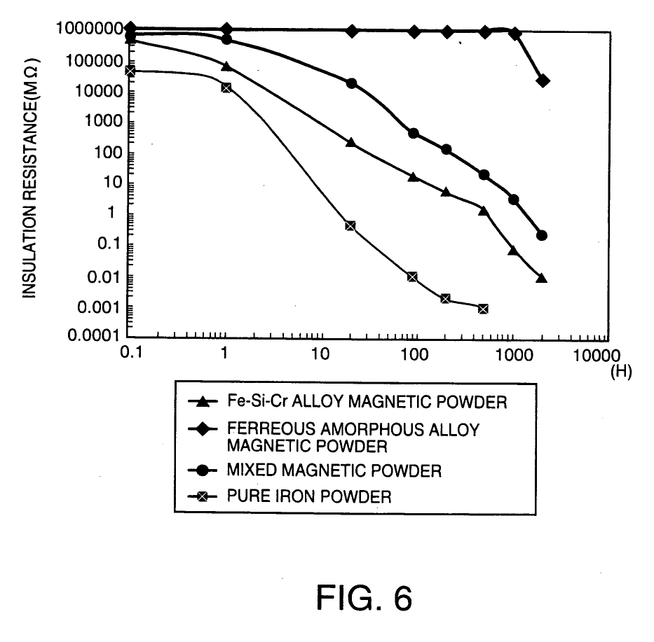

The characteristics of the mixed magnetic powder shown in FIG. 6 are those when the crystalline alloy magnetic powder and the amorphous alloy magnetic powder are mixed with matching ratios of 70 wt % to 80 wt %, and 30 wt % to 20 wt % respectively. As is clear from FIG. 6, although the ratio of the drop in the insulation resistance of the mixed magnetic powder is inferior to that when the amorphous alloy magnetic powder is used independently, it is better than when the crystalline alloy magnetic powder is used independently. The lifetime of the crystalline alloy magnetic powder at 100 degrees C. as determined from the calculation above was 64,000 hours, whereas here it is 128,000 hours. This can be regarded as a sufficient lifetime for normal use of a laptop computer, a server, and the like.

Furthermore, the “maximum density filling effect” achieves better permeability and core loss than when the crystalline alloy magnetic powder and the amorphous alloy magnetic powder are used independently, the improvement being between 10% and 20% better than when using them independently, depending on the mixing ratio. In the present test, the improvement was between 10% and 20%, but even better improvements can be expected after further study.

The complex magnetic material of this invention is obtained by mixing crystalline alloy magnetic powder with amorphous alloy magnetic powder, and additionally mixing therein an insulating connecting agent. A core, which was obtained by pressure-molding the complex magnetic material, and a magnetic element, comprising a winding coil or flat plate-like conductor buried in the core, have inferior insulation resistance drop characteristics at high temperatures to those of magnetic powder comprised only from the amorphous alloy magnetic powder. However, the problems of the magnetic element obtained by pressure-molding, namely that “permeability does not increase, the molded body has weak mechanical strength, and it requires annealing at high temperature” and the like, are greatly improved by using the magnetic powder obtained by mixing crystalline alloy magnetic powder with amorphous alloy magnetic powder.

By using the complex magnetic powder of this invention, characteristics such as permeability and core loss can be improved, and a highly reliable core and magnetic element having a low drop in insulation resistance can be obtained. Further, the complex magnetic material has excellent pressure-molding properties, so that the core and magnetic element obtained from it have high mechanical strength. A single-piece molded-type inductor, using a dust core comprising a metallic magnetic material, is capable of handling a large current, and is suitable for miniaturization and reducing costs, and for these reasons has been regarded as ideal; the improvements in electrical performance and insulation resistance drop characteristics obtained by the this invention present an important step toward its practical use.

What is claimed is:

1. A complex magnetic material, comprised by mixing ferrous crystalline alloy magnetic powder with ferrous amorphous alloy magnetic powder, thereby obtaining a complex magnetic powder, and additionally mixing therein a connecting agent of 1 wt % to 10 wt % of the mixed magnetic powder.

2. The complex magnetic material according to claim 1, wherein the matching ratios of the crystalline alloy magnetic powder, and the amorphous alloy magnetic powder, in the mixed magnetic powder are between 60 wt % to 90 wt %, and 40 wt % to 10 wt %, respectively.

3. The complex magnetic material according to claim 1, the composition of the crystalline alloy magnetic powder comprising a component X of 3 wt % to 12 wt % and the remainder being iron, the composition of the amorphous alloy magnetic powder comprising a component Y of 6 wt % to 20 wt % and the remainder being iron, the component X comprising at least one of Si, Cr, Ni, Nb, Ca, Ti, and Mg, and the component Y comprising at least one of Si, Cr, Ni, Co, Mo, B, and C.

4. The complex magnetic material according to claim 1, the average particle diameters of the crystalline alloy magnetic powder and the amorphous alloy magnetic powder being between 1 μm and 50 μm.

5. A core obtained by pressure-molding the complex magnetic material according to claim 1.

6. A magnetic element comprising at least one winding coil, which is buried in the core according to claim 5.

7. A magnetic element comprising at least one winding flat plate-like conductor, which is buried in the core according to claim 5.
